(19) United States
(12) Patent Application Publication
(10) Pub. No.: US 2024/0430537 A1
(43) Pub. Date: Dec. 26, 2024

(54) INFORMATION PLAYING METHOD, APPARATUS, ELECTRONIC DEVICE AND COMPUTER-READABLE STORAGE MEDIUM

(71) Applicant: BOE TECHNOLOGY GROUP CO., LTD., Beijing (CN)

(72) Inventors: Qifeng SHI, Beijing (CN); Xiao CHU, Beijing (CN)

(73) Assignee: BOE TECHNOLOGY GROUP CO., LTD., Beijing (CN)

(21) Appl. No.: 18/291,061

(22) PCT Filed: Sep. 22, 2022
(86) PCT No.: PCT/CN2022/120544

§ 371 Date: Jan. 22, 2024

(51) Int. Cl. H04N 21/4782; H04N 21/472; H04N 21/845; H04N 21/858

(52) U.S. Cl. CPC H04N 21/4782; H04N 21/47217; H04N 21/8456; H04N 21/8586

(57) ABSTRACT

A browser-based information playing method, apparatus, electronic device, and computer-readable storage medium are provided. The information playing method includes: acquiring media information to be played; selecting a target decoding library from a plurality of decoding libraries according to the attributes of the media information to be played, a plurality of decoding libraries being obtained by pre-compiling the decoding program in multiple ways, respectively; utilizing the target decoding libraries to decode the media information to be played to obtain playing information; and playing the playing information based on a browser.

### TECHNICAL FIELD

Embodiments of the present disclosure relate to an information playing method, an apparatus, an electronic device and a computer readable storage medium.

### BACKGROUND

The Internet has become an indispensable part of people's lives. As the window of the Internet, the browser plays an indispensable role in information dissemination, data sharing, public opinion guidance, leisure and entertainment, and even emotional communication.

Streaming media technology, as an early development technology, has become the mainstream technology of audio and video transmission and has been combined with the Internet.

### SUMMARY

At least one embodiment of the present disclosure provides a browser-based information playing method, which comprises: acquiring media information to be played; selecting a target decoding library from a plurality of decoding libraries according to attributes of the media information to be played, wherein the plurality of decoding libraries are obtained by pre-compiling a decoding program in multiple ways respectively; utilizing the target decoding library to decode the media information to be played to obtain playing information; and playing the playing information based on the browser.

For example, the information playing method provided by an embodiment of the present disclosure further comprises: creating a shared memory of a main thread and a decoding thread before acquiring the media information to be played, wherein the shared memory comprises a read-in memory; acquiring the media information to be played comprises: acquiring the media information to be played by the main thread and storing the media information to be played in the read-in memory; and utilizing the target decoding library to decode the media information to be played to obtain the playing information comprises: the decoding thread acquiring the media information to be played from the read-in memory and utilizing the target decoding library to decode the media information to be played to obtain the playing information.

For example, in the information playing method provided by an embodiment of the present disclosure, acquiring the media information to be played by the main thread and storing the media information to be played to the read-in memory comprises any of the following: acquiring, by the main thread, a uniform resource locator for the media information to be played, and acquiring the media information to be played based on the uniform resource locator, and storing the media information to be played into the read-in memory; acquiring the media information to be played by the main thread by a single read operation, providing the media information to be played to the read-in memory; or fragmenting the media information to be played into a plurality of media fragments, sequentially acquiring the plurality of media fragments by the main thread, sequentially storing the plurality of media fragments into the read-in memory.

For example, in the information playing method provided by an embodiment of the present disclosure, in response to fragmenting the media information to be played into the plurality of media fragments, the read-in memory comprises ring memory.

For example, in the information playing method provided by an embodiment of the present disclosure, a read-in data cursor is provided in the ring memory, the read-in data cursor indicates a current location in the ring memory where the media information to be played has been read by the decoding thread, and the method further comprises: in response to a data length of a current media fragment exceeding a memory length remaining in the ring memory, at least a portion of the data of the current media fragment overwrites a memory space between a queue head pointer of the ring memory to a location where the read-in data cursor is located.

For example, the information playing method provided by an embodiment of the present disclosure further comprises: triggering a read lock in response to a data length of a current media fragment being greater than an available length; the available length is equal to a sum of a difference between a total length of the read-in memory and a length of the media information currently stored in the read-in memory and a length between the queue head pointer of the read-in memory and the position where the read-in data cursor is located.

For example, the information playing method provided by an embodiment of the present disclosure further comprises: updating the read-in data cursor after the decoding thread consuming data in the read-in memory; updating the available length in the read-in memory according to an updated read-in data cursor; releasing the read lock in response to an updated available length in the read-in memory being greater than or equal to a data length of the current media fragment; and updating a flag bit in the shared memory to notify the decoding thread and the main thread that the read lock is released.

For example, in the information playing method provided by an embodiment of the present disclosure, the shared memory further comprises a write-in memory, the decoded playing information is written to the write-in memory, and playing the playing information based on the browser comprises: reading decoded playing information from the write-in memory; sequentially generating a plurality of media playing tasks based on the playing information; and executing the plurality of media playing tasks to play the playing information.

For example, in the information playing method provided by an embodiment of the present disclosure, the write-in memory is a ring memory and the write-in memory is provided with a write data cursor, the method further comprises: triggering a write lock in response to a data length of decoded data decoded and obtained by the decoding thread being greater than an available write-in memory length, wherein the decoded data is a portion of data in the playing information; the available write-in memory length is equal to a sum of a difference between a total length of the write-in memory and a length of the decoded data currently stored in the write-in memory and a length between a queue head pointer of the write-in memory and a position where the write data cursor is located.

For example, the information playing method provided by an embodiment of the present disclosure further comprises: updating the write data cursor after the main thread consuming data in the write-in memory; updating an available length in the write-in memory according to an updated write data cursor; releasing the write lock in response to an updated available length in the write-in memory being greater than or equal to a data length of the decoded data; and updating a flag bit in the shared memory to notify the decoding thread and the main thread that the write lock is released.

For example, in the information playing method provided by an embodiment of the present disclosure, the browser further comprises a browser database, decoded playing information is written to the browser database, and playing the playing information based on the browser comprises: reading the decoded playing information from the browser database; sequentially generating a plurality of media playing tasks based on the playing information; and executing the plurality of media playing tasks to play the playing information.

For example, in the information playing method provided by an embodiment of the present disclosure, the playing information comprises video data, and the plurality of media playing tasks comprises at least one video playing task; and sequentially generating a plurality of media playing tasks based on the playing information comprises: rendering the video data to sequentially generate the at least one video playing task.

For example, in the information playing method provided by an embodiment of the present disclosure, the playing information further comprises audio data, the plurality of media playing tasks comprises at least one audio playing task; and sequentially generating a plurality of media playing tasks based on the playing information further comprises: creating at least two audio task caches; and sequentially injecting the audio data in different time periods into the at least two audio task caches, wherein playing the audio data in each audio task cache is treated as an audio playing task.

For example, in the information playing method provided by an embodiment of the present disclosure, sequentially generating a plurality of media playing tasks based on the playing information further comprises: adjusting progress of the at least one audio playing task and the at least one video playing task, such that the at least one audio playing task and the at least one video playing task are synchronized.

For example, in the information playing method provided by an embodiment of the present disclosure, adjusting the progress of the at least one video playing task for each video frame played as a video playing task comprises: calculating, before each video playing task is executed, a delay duration of the video playing task for a current frame; updating an average delay duration based on a delay duration of the video playing task and an average delay duration of a history frame played before the current frame; and determining an actual playing duration of the video playing task and an execution moment of the video playing task for a next frame according to an updated average delay duration and a scheduled execution duration of the video playing task.

For example, in the information playing method provided by an embodiment of the present disclosure, calculating, before each video playing task is executed, a delay duration of the video playing task for a current frame comprises: acquiring a display timestamp of the current frame in the media information to be played; acquiring a scheduled execution duration of the video playing task; acquiring a first duration between an actual playing moment of starting playing of a first frame and an actual playing moment of the current frame; taking a first difference between the first duration and the display timestamp and a second difference between the scheduled execution duration as a delay duration of the current frame in the video playing task.

For example, the information playing method provided by an embodiment of the present disclosure further comprises: suspending the audio playing task in response to acquiring a pause operation at the first moment, the video playing task suspending a rendering task of a next frame; recording a second duration between an actual playing moment of starting playing of the first frame and the first moment; determining a remaining display duration of the current frame according to the second duration; in response to acquiring a resume operation, recording a resume moment at which the resume operation is acquired; updating a scheduled execution moment of the current frame to the resume moment; updating a scheduled execution duration of the current frame to the display duration; and updating the first duration to the second duration.

For example, the information playing method provided by an embodiment of the present disclosure further comprises: determining a first key frame of a gop interval of a frame corresponding to a second moment in response to acquiring a jump operation at the second moment; calculating a duration of each frame according to a frame rate; and determining a target frame to start playing from the target frame according to a duration of each frame.

At least one embodiment of the present disclosure provides a browser-based information playing apparatus, which comprises: an acquisition unit configured to acquire media information to be played; a selection unit configured to select a target decoding library from a plurality of decoding libraries according to attributes of the media information to be played, wherein the plurality of decoding libraries are obtained by pre-compiling a decoding program in multiple ways respectively; a decoding unit configured to utilize the target decoding library to decode the media information to be played to obtain playing information; and a playing unit configured to play the playing information based on the browser.

At least one embodiment of the present disclosure provides an electronic device, which comprises: a processor; a memory comprising one or more computer program instructions; the one or more computer program instructions are stored in the memory and implement the instructions of the information playing method of any one of the above embodiments when executed by the processor.

At least one embodiment of the present disclosure provides a computer-readable storage medium non-transitorily storing computer-readable instructions; the computer-readable instructions implement the information playing method of any one of the above embodiments when executed by a processor.

### BRIEF DESCRIPTION OF THE DRAWINGS

In order to clearly illustrate the technical solution of the embodiments of the present disclosure, the drawings of the embodiments will be briefly described. It is obvious that the described drawings in the following are only related to some embodiments of the present disclosure and thus are not limitative of the present disclosure.

FIG. 1 is a flow diagram of an information playing method provided by at least one embodiment of the present disclosure;

FIG. 2A is a flow diagram of another information playing method provided by at least one embodiment of the present disclosure;

FIG. 2B is a schematic diagram of step S60 and S70 in FIG. 2A provided by at least one embodiment of the present disclosure;

FIG. 2C is a schematic diagram of a linear memory provided by at least one embodiment of the present disclosure;

FIG. 3A is a method flowchart of step S40 in FIG. 1 provided by at least one embodiment of the present disclosure;

FIG. 3B is an alternative method flowchart of step S40 in FIG. 1 provided by at least one embodiment of the present disclosure;

FIG. 4A is a flowchart of a method for adjusting the progress of at least one audio playing task and at least one video playing task provided by at least one embodiment of the present disclosure;

FIG. 4B is a flowchart of another information playing method provided by at least one embodiment of the present disclosure;

FIG. 5 is a schematic diagram of a system architecture for applying the information playing method provided by at least one embodiment of the present disclosure;

FIG. 6A to FIG. 6C are flowcharts of another information playing method provided by at least one embodiment of the present disclosure;

FIG. 7 is a schematic diagram of synchronizing a video playing task with an audio playing task provided by at least one embodiment of the present disclosure;

FIG. 8 is a schematic block diagram of another information playing apparatus 800 provided by at least one embodiment of the present disclosure;

FIG. 9 is a schematic block diagram of an electronic device provided by at least one embodiment of the present disclosure;

FIG. 10 is a schematic block diagram of another electronic device provided by at least one embodiment of the present disclosure; and

FIG. 11 is a schematic diagram of a computer-readable storage medium provided by at least one embodiment of the present disclosure.

### DETAILED DESCRIPTION

In order to make objects, technical details and advantages of the embodiments of the present disclosure apparent, the technical solutions of the embodiments will be described in a clearly and fully understandable way in connection with the drawings related to the embodiments of the present disclosure. Apparently, the described embodiments are just a part but not all of the embodiments of the present disclosure. Based on the described embodiments herein, those skilled in the art can obtain other embodiment(s), without any inventive work, which should be within the scope of the present disclosure.

Unless otherwise defined, all the technical and scientific terms used herein have the same meanings as commonly understood by one of ordinary skill in the art to which the present disclosure belongs. The terms “first,” “second,” etc., which are used in the description and the claims of the present disclosure, are not intended to indicate any sequence, amount or importance, but distinguish various components. Likewise, the terms such as “a,” “an,” or “the” do not indicate a limitation of amount, but rather indicate the presence of at least one. The terms “comprise,” “comprising,” “include,” “including,” etc., are intended to specify that the elements or the objects stated before these terms encompass the elements or the objects and equivalents thereof listed after these terms, but do not preclude the other elements or objects. The phrases “connect”, “connected”, etc., are not intended to define a physical connection or mechanical connection, but may include an electrical connection, directly or indirectly. “On,” “under,” “left,” “right” and the like are only used to indicate relative position relationship, and when the position of the object which is described is changed, the relative position relationship may be changed accordingly.

Streaming media technology has evolved to the present day, and there are a wide variety of codec technologies available, such as the most widely used H264, H265 with higher compression ratio. Although the compression ratio of H265 is higher and the bandwidth is lowered, it is difficult to land on the browser due to the high cost of using H265. Based on the browser's own needs and the lightness of the Internet, browsers usually cut multimedia functionally, which leads to the differentiation of the browser's coding and decoding capabilities. As a result, the multimedia playing capabilities of browsers are confusing and limited. As a result, it is often the case that a browser is unable to play a certain audio or video for various reasons.

At least one embodiment of the present disclosure provides a browser-based information playing method, an information playing apparatus, an electronic device, and a computer-readable storage medium. The information playing method includes: acquiring media information to be played; selecting a target decoding library from a plurality of decoding libraries according to attributes of the media information to be played, a plurality of decoding libraries being obtained by pre-compiling the decoding program in multiple ways, respectively; utilizing the target decoding libraries to decode the media information to be played to obtain playing information; and playing the playing information based on a browser. The information playing method can alleviate the problem of multimedia being difficult to play on a browser in a complex codec environment.

FIG. 1 is a flowchart of an information playing method provided by at least one embodiment of the present disclosure.

As shown in FIG. 1, the method may include steps S10˜S40.

Step S10: Acquiring media information to be played.

Step S20: selecting a target decoding library from a plurality of decoding libraries according to the attributes of the media information to be played, the plurality of decoding libraries being obtained by pre-compiling the decoding program in multiple ways respectively.

Step S30: utilizing the target decoding library to decode the media information to be played to obtain the playing information.

Step S40: playing the playing information based on a browser.

The information playing method pre-compiles the decoding program into various versions of the decoding libraries, so that the browser can select from the various versions of the decoding libraries the decoding library that is adapted to the attributes of the media information to be played to decode, which makes the browser's decoding capability universal, and alleviate the problem of the multimedia being difficult to be played back in the browser under the complex coding and decoding environment.

For step S10, the media information to be played may be, for example, audio data, video data, or audio/video data, etc. The media information to be played may be a variety of video compression types such as h264, hevc, av1, vpx, MPEG-2 or MPEG-4.

For example, a browser accesses a unified resource locator of an audio/video playing website to acquire the media information to be played.

Another example is that the browser receives the media information to be played from the cloud.

For step S20, the attributes of the media information to be played may include, for example, a compression type of the media information to be played, a supported terminal version of the media information to be played, and the like.

For example, ffmpeg which integrates the ability of open hevc and other decoders can be pre-compiled as a static library for users to call. Due to the different environments of each terminal, ffmpeg can be pre-compiled into many versions of static libraries, such as the version that can only be decoded in a single thread, the version that can be decoded in multiple threads (thread pooling), the x86 version, the x64 version, the arm version, etc. These different types of static libraries serve as multiple decoding libraries. Selecting the target decoding library from the multiple decoding libraries according to the different types of terminals can achieve the optimal allocation of resources and realize an adaptive decoder.

In some embodiments of the present disclosure, for example, a ffmpeg-based application package is used as the basis for writing C-based decoding scripts for decoding audio and video, so that the C decoding scripts are pre-compiled into a decoding library of web assembly language. It is typically javascript scripts that can be run on a browser, so the web assembly language and the js glue codes are bonded together to form a complete closed loop system.

In some embodiments of the present disclosure, a plurality of decoding libraries may be stored in the cloud to save storage space local to the browser.

In some embodiments of the present disclosure, after the browser determines a target decoding library, the target decoding library may be downloaded from the cloud and the target decoding library may be stored in a cache for use. In this example, the browser needs to re-download the target decoding library from the cloud each time it performs a playing operation.

In other embodiments of the present disclosure, after the browser downloads the target decoding library from the cloud, it may store the target decoding library into a database of the browser. In this example, the browser can directly acquire the target decoding library from the database without repeatedly downloading the target decoding library from the cloud, which improves playing efficiency.

For example, a correspondence table of attributes and decoding libraries is stored in the browser, and the correspondence table is looked up according to the attributes of the media information to be played. If the target decoding library corresponding to the attribute is found in the correspondence table, it indicates that the target decoding library has been stored in the database, and the target decoding library is directly obtained from the database. If the target decoding library corresponding to the attribute is not found in the correspondence table, it indicates that the target decoding library is not stored in the database, the target decoding library is downloaded from the cloud, and the target decoding library is stored in the database or cached.

In other embodiments of the present disclosure, a plurality of decoding libraries may be directly stored in the database of the browser without downloading from the cloud, which improves the playing efficiency.

For step S30, for example, if the terminal is an X86 version, the pre-compiled ffmpeg of X86 version is utilized to decode the media information to be played to obtain the playing information.

In some embodiments of the present disclosure, for example, the playing information obtained by the target decoding library decoding the media information to be played is in the format of fmp4. fmp4 puts the underlying information in a moof packet one by one, and forms a kind of streaming media data by the pattern of ftyp+moof+mdata+moof+mdata. Because the streaming media data in fmp4 format are moof packets, the streaming media data in fmp4 format can be disassembled arbitrarily, which is more flexible.

For step S40, the playing information is played on a browser, for example.

As shown in FIG. 1, the information playing method further includes creating shared memory for the main thread and the decoding thread, the shared memory including read-in memory. For example, creating the shared memory for the main thread and the decoding thread is performed after step S10 and before S20.

In embodiments of the present disclosure, the main thread is a javascript script running on a browser. The main thread is mainly responsible for the rendering of the page, and due to the single-threaded nature of the javascript script, the main thread does not take on the work that requires huge arithmetic power, and instead transfers such work to the worker threads, such as to the decoding thread. The decoding thread utilizes the target decoding library to decode the media information to be played.

The shared memory is shared between the main thread and the decoding thread to achieve multi-threading and decoding acceleration, and a section of heap memory data is shared between the main thread and the decoding thread to achieve efficient data utilization. The main thread continuously sends the media information to be played to the shared memory, and the decoding thread continuously reads the media information to be played from the shared memory to decode the media information to be played.

In some embodiments of the present disclosure, for example, the shared memory is used in conjunction with the use of the https protocol of protocol layer, which saves storage space while isolating possible risks, isolates external attacks, and improves security.

In this embodiment, step S10 in FIG. 1 of obtaining the media information to be played may comprise acquiring the media information to be played by the main thread and storing the media information to be played into a read-in memory. That is, the read-in memory is used to store the media information to be played acquired by the main thread.

In some embodiments of the present disclosure, acquiring the media information to be played by the main thread and storing the media information to be played to the read-in memory may comprise: acquiring a uniform resource locator (URL) of the media information to be played by the main thread, acquiring the media information to be played based on the uniform resource locator, and storing the media information to be played to the read-in memory. In the following, this embodiment is referred to as the URL acquisition method.

In other embodiments of the present disclosure, acquiring the media information to be played by the main thread and storing the media information to be played to the read-in memory may comprise: acquiring the media information to be played by the main thread through a single read operation and providing the media information to be played into the read-in memory at one time. In the following, this embodiment will be referred to as the one-time acquisition method.

In other embodiments of the present disclosure, the media information to be played is fragmented into a plurality of media fragments, a plurality of media fragments are sequentially acquired by the main thread, and a plurality of media fragments will be sequentially stored to the read-in memory. In the following, this embodiment will be referred to as the fragmentation acquisition method.

In some embodiments of the present disclosure, the URL acquisition method and the one-time acquisition method are applicable to on-demand broadcasting of audio and video, and the fragmentation acquisition method is applicable to live broadcasting of audio and video.

In some embodiments of the present disclosure, in response to the fragmentation of the media information to be played into a plurality of media fragments, the read-in memory comprises a ring memory. The ring memory helps to achieve a high degree of memory reuse with limited memory.

In some embodiments of the present disclosure, a read-in data cursor is provided in the ring memory, and the read-in data cursor indicates a current location in the ring memory at which the media information to be played is read by the decoding thread.

In this embodiment, step S30 in FIG. 1 may comprise: the decoding thread acquiring the media information to be played from the read-in memory, and using a target decoding library to decode the media information to be played to obtain the playing information.

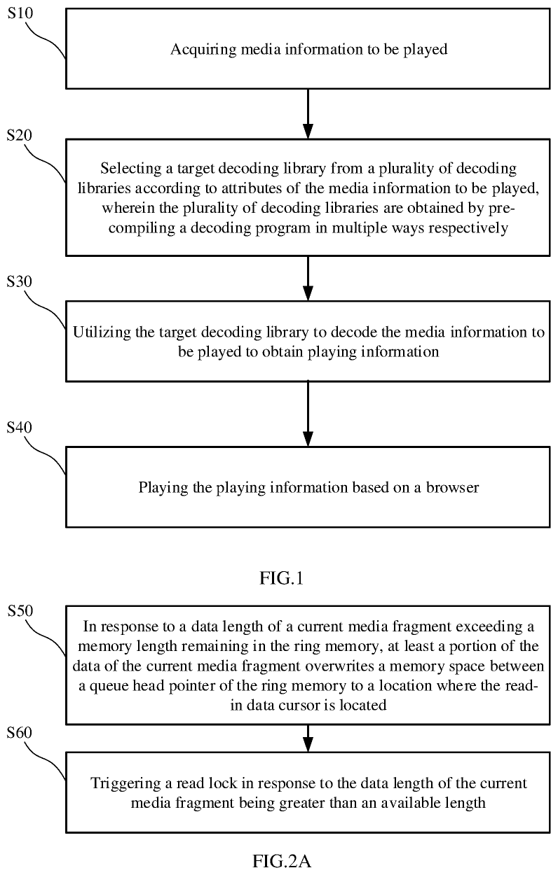

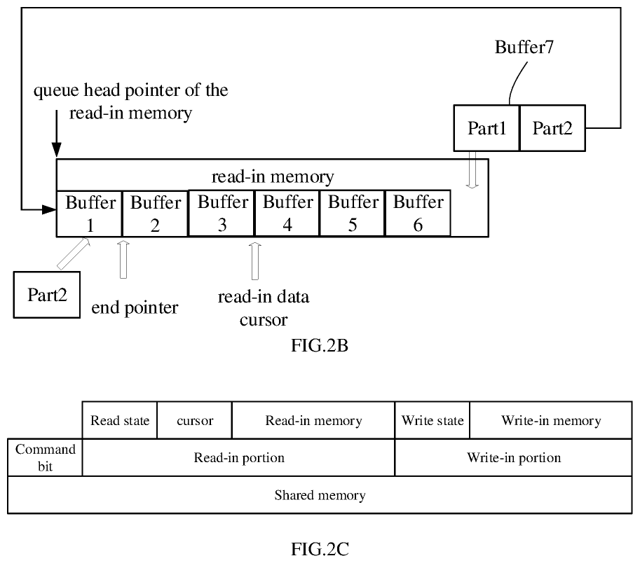

FIG. 2A is a flowchart of another information playing method provided by at least one embodiment of the present disclosure.

As shown in FIG. 2A, the information playing method may comprise step S50 in addition to step S10˜step S40.

Step S50: In response to the data length of the current media fragment exceeding the remaining memory length of the ring memory, at least a portion of the media information to be played to be stacked covers a memory space between a queue head pointer of the ring memory and a location where the read-in data cursor is located.

The method enables a high degree of reuse of the ring memory.

For example, the main thread continually stacks the latest streaming media packet (i.e., the current media fragment) into the read-in memory. If the length of the latest streaming packet exceeds the length of the read-in memory, it returns to the queue head pointer of the read-in memory to overwrite the memory data prior to the location of the current read-in data cursor, thus ensuring a high degree of memory reuse with limited memory.

As shown in FIG. 2A, the information playing method may further comprise a step S60 based on step S50.

Step S60: In response to the data length of the current media fragment being greater than the available length, triggering a read lock.

In embodiments of the present disclosure, the available length is equal to the sum of the difference between the total length of the read-in memory and the length of the media information currently stored in the read-in memory and the length between the queue head pointer of the read-in memory and the location where the read-in data cursor is located.

For example, available length=(read-in memory length−queue end pointer of the read-in memory)+ (queue head pointer of the read-in memory−location where the read-in data cursor is located).

The method can achieve behavior isolation by setting read locks and provides memory security and atomicity.

FIG. 2B is a schematic diagram of steps S50 and S60 of FIG. 2A provided by at least one embodiment of the present disclosure.

As shown in FIG. 2B, the read-in memory is a ring memory with the head and tail of the ring memory connected. The read-in memory has stored media fragments Buffer 1˜Buffer 6. The read-in data cursor is located at the first end of Buffer 4, i.e., the decoding thread reads Buffer 1˜Buffer 3 from the read-in memory.

The main thread needs to stack the latest streaming packet (i.e., current media fragment Buffer 7) into the read-in memory.

Because the data length of the current media fragment Buffer 7 is greater than the length of the memory space in the read-in memory from the queue tail to the queue head pointer of the read-in memory (i.e., the remaining memory length of the read-in memory) and less than the available length, the current media fragment Buffer 7 is split into the first part Part1 and the second part Part2 for storage. The available length is the sum of the length of the memory space from the queue tail to the queue head pointer of the read-in memory and the length of the memory occupied by Buffer 1˜Buffer 3.

The first part Part1 is put into the memory space from the queue tail to the queue head pointer in the read-in memory. The second part Part2 returns to the queue head pointer of the read-in memory, overwrites the memory data prior to the location where the current read-in data cursor is located and updates the tail of the queue to the tail of the second part Part2.

As another example, if the data length of the current media fragment Buffer 7 is greater than the available length, a read lock is triggered.

In some embodiments of the present disclosure, the information playing method, further comprises: updating the read-in data cursor after the decoding thread consumes the data in the read-in memory; updating the available length of the read-in memory according to the updated read-in data cursor; releasing the read lock in response to the updated available length in the read-in memory being greater than or equal to the data length of the current media fragment; and updating a flag bit in the shared memory to notify the decoding thread and the main thread that the read lock is released.

For example, when the read lock is triggered, the decoding thread still continuously acquires the media fragment streaming from the read-in memory, i.e., the decoding thread consumes the data in the read-in memory, and thus the read-in data cursor is continuously updated and the available length is continuously increasing until the data length of the current media fragment Buffer 7 is less than or equal to the available length, releasing the read lock.

In some embodiments of the present disclosure, the shared memory further comprises a write-in memory into which the decoded playing information is written. For example, the write-in memory is a ring memory.

In other embodiments of the present disclosure, the shared memory is a linear memory, i.e., both the read-in memory and the write-in memory are linear memory.

FIG. 2C is a schematic diagram of a linear memory provided by at least one embodiment of the present disclosure.

As shown in FIG. 2C, the shared memory is a linear memory. The linear memory is divided into a command bit, a read-in portion, and a write-in portion.

The command bit may be, for example, a byte table type followed by 16 bytes of reserved bits as parameters. The command bit is used to store user commands such as jump, pause, resume, stop, rewind, multiplex, etc. Parameters can be, for example, the time of the jump, etc.

The read-in memory of the read section is used to store the above media information to be played, and the write-in memory of the write section is used to store the decoded playing information the media information to be played.

The read state of the read-in portion indicates the lock state of the read-in memory heap. For example, state has only 1 byte, 1 indicates the read-in memory is locked, 0 indicates the read-in memory is unlocked. The cursor indicates the read bit and write bit of the read-in memory.

The cursor of the read section indicates the read bits and write bits of the read-in memory heap. The write bit is used to record the location where the fragmented byte stream is written to the read-in memory heap, and the read bit is used to record the location where the fragmented byte stream is read.

The write state of the write section indicates the lock state of the write-in memory heap. Similar to the above, the read state can only comprise 1 byte, with 1 indicating that the read-in memory is locked and 0 indicating that the read-in memory is unlocked.

The use of ring memory in shared memory can save space. For example, when the player plays low-definition videos, the shared memory may be linear memory, and when the player plays high-definition videos, the shared memory may be ring memory. For example, when the player is switched from playing low-definition videos to playing high-definition videos, the shared memory is switched from the linear memory to the ring memory to save storage space and improve playing efficiency.

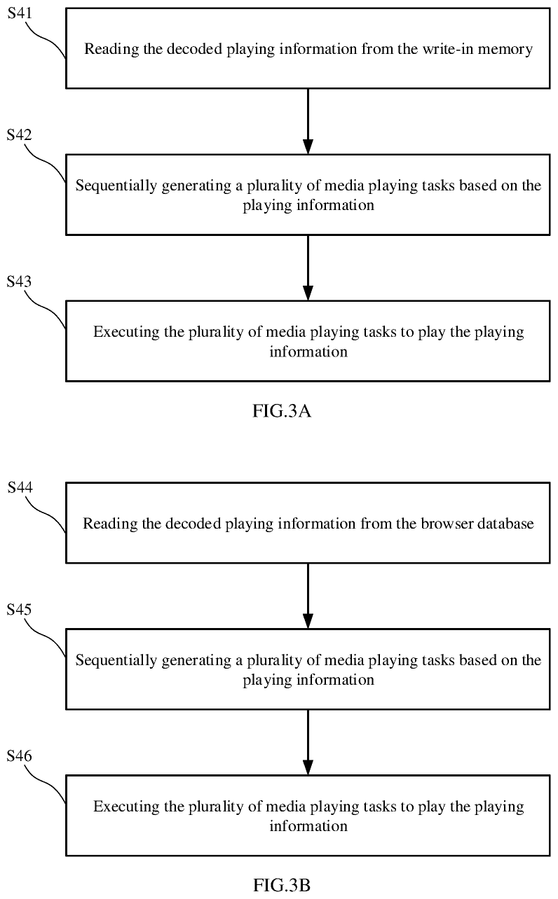

FIG. 3A is a method flowchart of step S40 of FIG. 1 provided by at least one embodiment of the present disclosure.

As shown in FIG. 3A, the step S40 may comprise steps S41˜S43.

Step S41: reading the decoded playing information from the write-in memory.

Step S42: generating a plurality of media playing tasks in sequence based on the playing information.

Step S43: executing a plurality of media playing tasks to play the playing information.

In some embodiments of the present disclosure, steps S41˜S43 can be executed by the main thread of the browser.

For step S41, for example, the main thread reads the decoded playing information from the write-in memory. Reading the write-in memory requires reading according to the data format. The following table schematically shows a data format for write-in memory storage. In the following table, yuv data represents video data, y represents the brightness of an image in the video, u represents color and v represents saturation.

| | First | | | | | | | | | | |
|---|---|---|---|---|---|---|---|---|---|---|---|
| First | byte | Last 4 | Next 4 | | | | | | | | |
| byte | description | bytes | bytes | Specific data format | | | | | | | |
| 00 | YUV | unsigned | YUV | 8 bytes | 8 bytes | 4 bytes | Byte | 4 bytes | Byte | 4 bytes | Byte |
| | data | int | data | | | | stream | | stream | | stream |
| | | location of | length | unsigned | unsigned | Y | Y | U | U | V | V |
| | | the pointer | | long | long | channel | channel | channel | channel | channel | channel |
| | | stored in | | frame | frame | data | data | data | data | data | data |
| | | the | | playing | playing | length | length | length | length | length | |
| | | write-in | | moment | duration | | | | | | |
| | | memory | | (ms) | (ms) | | | | | | |
| 01 | pcm | unsigned | Pcm | 8 bytes | 8 bytes | 4 bytes | Byte | 4 bytes | Byte | 4 bytes | Byte |
| | data | int | data | | | | stream | | stream | | stream |
| | | location of | length | unsigned | unsigned | pcm | First | First | Second | Second | . . . |
| | | the pointer | | long | long | total | channel | channel | channel | channel | |
| | | stored in | | sample | frame | number | data | data | data | data | |
| | | the | | playing | playing | of | packet | | packet | | |
| | | write-in | | moment | duration | samples | length | | length | | |
| | | memory | | (ms) | (ms) | | | | | | |

For step S42, for example, the playing information comprises audio data and video data, the audio playing tasks are generated according to the audio data, and the video playing tasks are generated according to the video data.

In some embodiments of the present disclosure, for the video data, for example, a frame of video is played as a video playing task.

For audio, the sampling data of audio is very large, and audio playing generally requires connecting an audio playing device beforehand. If calculated based on a 30 fps audio/video stream, one frame of audio sampling set is sent over and needs to be connected once, and it needs to be connected/disconnected 30 times per second, which will seriously interfere with audio playing, waste a large amount of time on connection waiting, and the user will hear intermittent sound, which is a poor experience. Therefore, for audio, in this disclosure, a large batch sampling set is used for playing. That is, unlike the video playing task of one frame at a time, audio collects all the audio data in the write-in memory at once, and forms a large stream of audio files. For example, pulse code modulation (pcm) sampling data (i.e., the stream of audio files) is split into audio tracks and encapsulated in the cache of the AudioContext interface of the Web. This can improve audio smoothness. Therefore, for audio, playing a pcm sampling set can be considered as an audio playing task.

For example, if the playing information comprises video data and a plurality of media playing tasks comprise at least one video playing task, step S42 comprises: rendering the video data and generating the at least one video playing task sequentially.

For example, a 3D graphics protocol (Web Graphics Library, webgl) is utilized for rendering and fast refreshing of the video frames.

For example, if the playing information also comprises audio data, a plurality of media playing tasks comprise at least one audio playing task. The step S42 further comprises: creating at least two audio task caches; and sequentially injecting audio data in different time periods into the at least two audio task caches, and playing the audio data in each of the audio task caches as one audio playing task.

Because it is not possible to add new sampling data to the caches in the AudioContext interface after the audio is played, a new Audio Context interface is re-opened in some embodiments of the present disclosure, and it is necessary to prepare the Audio Context interface and connect the playing apparatus beforehand in order not to generate a broken audio. For the audio playing task, it is actually a process of alternating playing of pcm sampling data in two Audio Context interfaces. Each time a new audio playing task is started, two AudioContext interfaces are prepared and connected to the playing apparatus, one of which serves the current task, and the other needs to be injected into the pcm sampling data before the end of the current task and start playing immediately at the end of the former. Compared to the video YUV data, the pcm sampling data is relatively small and the playing time is relatively long. According to the calculation formula: pcm bytes/seconds=sampling apparatus frequency×(sound card sampling bits/8)×number of audio channels. If calculated based on a dual channel with a frequency of 44.1 khz and a sound card sampling bit of 16, the data is 176.4 kb/s. Typically, the encoding algorithm for pcm is aac, with a compression ratio of 18:1, so it only takes about 10 k to play audio for 1 second. Therefore, for the scenario of live broadcasting, i.e., 10 k can be cached to start the playing, so it is basically a second to start.

For step S43, for example, the audio playing task and the video playing task are performed simultaneously.

In some embodiments of the present disclosure, the write-in memory is set with a write-in data cursor, and the information playing method further comprises: triggering a write-in lock in response to the data length of the decoded data obtained by decoding thread decoding being greater than the available write-in memory length. The decoded data is a portion of the data in the playing information. This step is performed, for example, after step S30 and before step S41.

The decoding thread sequentially reads a portion of the data of the media information to be played from the read-in memory, and decodes the portion of the data of the media information to be played in this read-in to obtain decoded data. The decoding thread provides the decoded data to the write-in memory, and the write-in memory stores the decoded data, which is the portion of the playing information.

The available write-in memory length is equal to the sum of the difference between the total length of the write-in memory and the length of the playing information currently stored in the write-in memory and the length between the queue head pointer of the write-in memory and the location where the write-in data cursor is located.

In some embodiments of the present disclosure, it further comprises: updating the write-in data cursor after the main thread consumes the data in the write-in memory; updating the available length in the write-in memory according to the updated write-in data cursor; releasing the write-in lock in response to the updated available length in the write-in memory being greater than or equal to the data length of the decoded data; and updating a flag bit in the shared memory to notify the decoding thread and the main thread of write release.

For example, when the write-in lock is triggered, the main thread still continuously acquires the decoded data from the write-in memory, i.e., the main thread consumes the decoded data in the write-in memory, and thus the write-in data cursor is continuously updated and the available length in the write-in memory is continuously increasing until the data length of the decoded data is less than or equal to the available length in the write-in memory and the write-in lock is released.

Triggering and releasing the write-in lock of this write-in memory are similar to reading lock depicted in FIG. 2B above and will not be repeated herein.

In some embodiments of the present disclosure, the browser further comprises a browser database, and the decoded playing information is written to the browser database. For example, the browser database is indexDB. Due to the space of the shared memory is limited and yuv data is generally large, when the user's terminal has limited memory, the indexDB mode can be enabled to load the decoded yuv data onto the indexDB. The main thread (js script) on the page can then use tokens to asynchronously fetch data from the browser's indexDB, thereby saving the problem of huge intermediate data in the decoding process.

FIG. 3B is an alternative method flowchart of step S40 of FIG. 1 provided by at least one embodiment of the present disclosure.

As shown in FIG. 3B, step S40 may comprise steps S44˜S46.

Step S44: reading the decoded playing information from the browser database.

Step S45: generating a plurality of media playing tasks sequentially based on the playing information.

Step S46: executing a plurality of media playing tasks to play the playing information.

For step S44, for example, when the player is initialized for the first time, the decoded byte stream and corresponding decoding thread script will be printed into blob data and loaded into the page. This method is to facilitate the opening of multiple players on the page. If there are multiple instances, there will be differences. Therefore, a unique token will be generated incrementally based on the globally unique index from 0 to facilitate page differentiation processing, such as indexDB data retrieval, etc., if it is set to indexDB frame retrieval, the token will also be passed to the decoder part in the form of parameters during initialization, making it convenient for the decoder to directly load the decoded data to the indexDB. The key value is token+_+frame playing time point.

Step S45 and step S46 are similar to step S42 and step S43 in FIG. 3A.

In addition to steps S41˜S43 in FIG. 3A or steps S44˜S46 in FIG. 3B, step S40 may comprise: adjusting the progress of at least one audio playing task and at least one video playing task, such that the at least one audio playing task and the at least one video playing task are synchronized.

In some embodiments of the present disclosure, the information playing method described above consumes the computing power of CPU, and most CPU instructions are single instruction single result sets. This leads to the phenomenon that the execution of information playing will compete with other processes or systems for CPU execution rights. Therefore, thread hanging may occur when CPU computing power cannot be guaranteed. Therefore, at least one embodiment of the present disclosure proposes adjusting the progress of at least one audio playing task and at least one video playing task, such that at least one audio playing task and at least one video playing task are synchronized, i.e., audio and video time lag catch-up is performed.

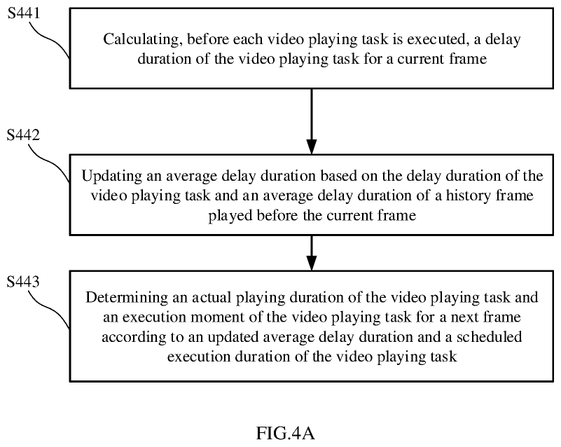

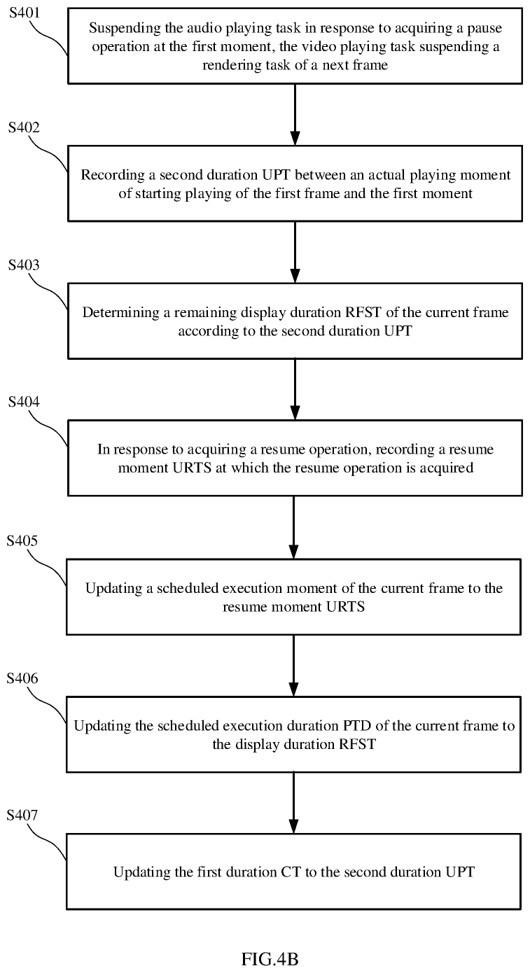

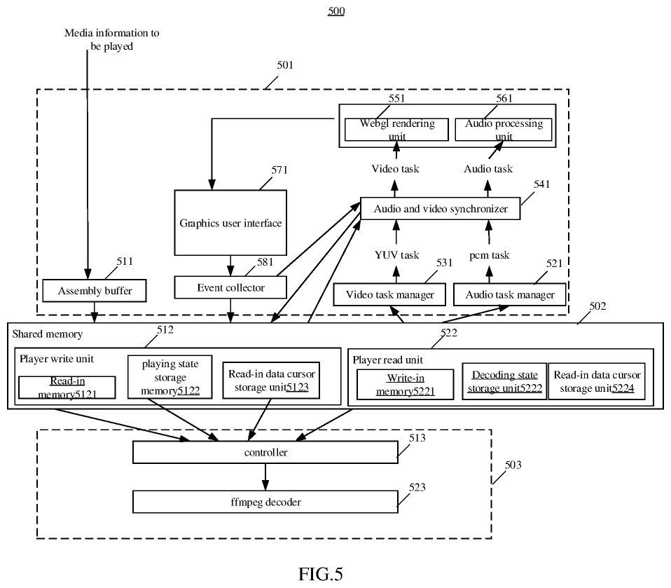

FIG. 4A is a flowchart of a method for adjusting the progress of at least one audio playing task and at least one video playing task provided by at least one embodiment of the present disclosure.

As shown in FIG. 4A, the method may comprise steps S441˜S443.

Step S441: before each video playing task is executed, a delay duration of the video playing task for the current frame is calculated.

Step S442: updating the average delay duration based on the delay duration of the video playing task and the average delay duration of historical frames played before the current frame.

Step S443: determining an actual playing duration of the video playing task and the execution moment of the video playing task for the next frame according to the updated average delay duration and the scheduled execution duration of the video playing task.

For step S441, the delay duration of the video playing task for the current frame may be a difference between the scheduled playing moment of the current frame and the actual playing moment of the current frame.

The delay duration may be a positive value or a negative value. For example, if the scheduled playing moment of the current frame is earlier than the actual playing moment of the current frame, the delay duration of the video playing task for the current frame is a positive value, and if the scheduled playing moment of the current frame is later than the actual playing moment of the current frame, the delay duration of the video playing task for the current frame is a negative value. In some other embodiments of the present disclosure, the audio and video time lag catch-up in steps S442˜S443 is only performed when the delay duration is greater than 0; If the delay duration is less than 0, the audio and video time lag catch-up is not performed, which can reduce the fluctuation range of audio and video adjustments and improve the user experience.

In some embodiments of the present disclosure, step S441 may comprise: acquiring a display timestamp PTS of the current frame in the media information to be played; acquiring a scheduled execution duration PTD of the video playing task; acquiring a first duration CT between the actual playing moment of the start of playing of the first frame and the actual playing moment of the current frame; and taking the first difference between the first duration and the display timestamp and the second difference between the scheduled execution duration as the delay duration Gap of the current frame in the video playing task, i.e., Gap=CT−PTS−PTD.

In some embodiments of the present disclosure, for example, an independent system timeline ticker is established. The ticker, for example, defaults to 100 milliseconds a jump. Each jump of the ticker first checks the execution moment and duration of the previous ticker, and calculates the time difference TD between the actual execution moment of the current ticker and the actual execution moment of the previous ticker. For the media information to be played that comprises both audio and video, update the first duration CT of this time according to the playing time point PT of the previous ticker, CT=PT+TD, and record the Ticker Time (TT). The first duration CT is the duration of the playing task starting from 0, and the video needs to use this as the alignment timeline when playing. In fact, for example, if the previous TT is marked as PTT, then TD=TT−PTT, so CT=TT−PTT+PT. In addition, for media information to be played that only has audio but no video, or for media information to be played that only has video but no audio, CT will also be updated every time the task is switched. The update method is to obtain the current moment NT through the browser during calculation, and calculate CT=PT+NT−TT. At the same time, the audio and video tasks are continuously created and executed in sequence. Video tasks are one task per frame, audio tasks are one task per large pcm sampling set, each task is in its own queue, with a task plan execution moment PSTS, a scheduled execution duration PTD of video playing task, an actual execution moment ASTS of the task, an actual execution duration ATD of the task and the display timestamp PTS of the current frame in the media information to be played. Firstly, describe the task part of next frame. Before each frame task is executed, the current moment ASTS will be checked. If ASTS>PSTS+PTD, which means that the frame has timed out and the task does not need to be created again, skip the task and continue to plan the task of next frame. Otherwise, make the delay duration of the video playing task for the current frame be Gap=CT-PTS-PTD.

For step S442, the average delay duration AvgGap′ is updated, for example, according to the following formula.

$${AvgGap}^{′} = ( Gap + AvgGap * ( TaskNumber - 1 ) ) / TaskNumber .$$

Gap is the delay duration of the video playing task for the current frame calculated at step S441, and TaskNumber is the number of times the video playing task has been executed. For each execution of the video playing task, TaskNumber+1. AvgGap is the average delay duration of the historical frames played before the current frame.

For step S443, for example, the actual playing duration ATD of the video playing task is the maximum value between 0 and the minimum playing value. The minimum playing value is the minimum value between the difference between the task plan execution duration PTD and the delay duration Gap of the video playing task for the current frame and the difference between the task plan execution duration PTD and the average delay duration AvgGap′. That is, ATD=Max(0, Min(PTD−Gap, PTD−AvgGap′)).

The scheduled execution moment of the video playing task for the next frame Next PSTS is equal to the sum of the actual playing duration ATD of the current video playing task and the playing time point PT of the previous ticker. The scheduled playing duration is the duration of the decoded data of the next frame duration.

Because video playing is a continuous process, the task that has already been played cannot be modified, so what can be modified is to keep correcting the playing parameters of the next frame on the basis of the task that has already been played, so that it can be resumed to the original playing point as soon as possible. Therefore, when there is a difference between the current frame and the scheduled playing time point, this time difference Gap will be recorded and the average value will be taken according to the task of each frame, and the average value will be constantly updated. If the average value is too large, the ATD will rapidly decrease, or even directly reach 0, while the frame is increasing. Therefore, AvgGap will be gradually lowered at this time, and the ATD may be gradually raised, so it will float up and down, ultimately forming a dynamic balance, completing the catch-up mechanism, so that ATD exists in a balanced way near the playing curve of the original stream.

For audio data, because audio is a big chunk of pcm data packets, it is not suitable for frequent checking. Considering the lightweight and coherence of audio, the audio track playing is bound to the system timeline. Therefore, every time a pcm task is created, CT=AudioET is updated, where AudioET is the sum of the duration in the pem sampling data, and TT is updated. In this way, due to CT being adjusted, the video frame data will quickly regress and be adjusted to the timeline corresponding to the audio track. At this point, the audio and video collaboration work has been completed.

The system timeline is established by the method, CT and TT of the system time are updated by using the summation of the duration of the audio, and the system timeline is constantly corrected, which results in a more accurate playing time point of the audio and video, as well as a better synchronization effect of the audio and video.

In some embodiments of the present disclosure, the information playing method may further comprise: acquiring an input operation of the user, and controlling the browser to play the playing information according to the input operation of the user.

In some embodiments of the present disclosure, the input operation may comprise, for example, a pause operation, a resume operation after the pause operation, a jump operation, and the like.

FIG. 4B is a flowchart of another information playing method provided by at least one embodiment of the present disclosure.

As shown in FIG. 4B, the information playing method may further comprise steps S401˜S407 in addition to the aforementioned steps.

Step S401: In response to acquiring a pause operation at the first moment, the video playing task hangs the rendering task of the next frame and pauses the audio playing task.

Step S402: recording the second duration UPT between the actual playing moment when the first frame starts to play and the first moment.

Step S403: determining a remaining display duration REST of the current frame according to the second duration UPT.

Step S404: in response to acquiring the resume operation, recording the resume moment URTS of the acquisition of the resume operation.

Step S405: updating the scheduled execution moment of the current frame to the resume moment URTS.

Step S406: updating the scheduled execution duration PTD of the current frame to the display duration RFST.

Step S407: updating the first duration CT to the second duration UPT.

For steps S401 and S402, for example, when a user triggers a pause operation, the video frame task hangs the rendering task of the next frame, the Audio Context opens the pause state, and the system time ticker is interrupted. During pause, the pause moment UPTS (i.e., the first moment) and the time being played will be recorded. The time being played during pause is the second duration UPT between the actual playing moment starting from the first frame and the first moment.

For step S403, the current frame also requires the display duration RFST to be the maximum value between 0 and a remaining duration t1. The remaining duration is the result of the actual execution duration ATD of the video playing task minus the difference between the second duration and the playing time point PT of the previous ticker. That is, the remaining duration t1=ATD−UPT−PT. For audio, because the audio data is bound to the system timeline, direct resume is sufficient without the need to record the time.

For step S404, for example, when a user triggers a resume operation, the resume moment URTS at which the resume operation is acquired is recorded, the ticker jump is resumed and CT and TT of the ticker are updated to PT and PTT.

For step S405, the scheduled execution moment PSTS of the current frame is updated to URTS, the scheduled execution duration PTD of the current frame is updated to RFST, the actual execution moment ASTS of the task is updated to URTS, the actual execution duration ATD of the task is updated to RFST, CT is updated to UPT, and TT is updated to URTS, i.e., the task queue is restarted.

It should be noted that the audio operation requires a delay because it is a process of disconnecting the hardware device, so the above moments/times are all moments/times calculated after disconnection/connection.

In some embodiments of the present disclosure, the information playing method may further comprise: determining the first key frame of a gop interval of a frame corresponding to the second moment in response to acquiring a jump operation at the second moment; calculating the duration of each frame according to the frame rate; and determining a target frame to start playing from the target frame according to the duration of each frame.

For example, the jump operation is used to quickly localize to a certain moment and continue decoding/playing. When a jump is triggered, the decoding packet will be updated and the write-in data cursor will be reset, while the decoder will obtain the jump state and interrupt decoding to enter the jump process, clearing the write-in memory. At the same time, the decoder will find the first key frame in the gop interval of the corresponding frame at that moment, i.e. I-frame. The decoder calculates the duration of each frame according to the frame rate fps of the video, completes the frames that need to be ignored after the I-frame, extracts the target frame, and updates it to the write-in memory. It's worth mentioning that for jump, it's necessary to preserve the original video data that was previously written to memory. For live streaming, it is not necessary to preserve a lot of data, so there is no jump in live streaming. Similarly, fast forward/backward, that is, jumping forward N×1000 milliseconds per second based on jumping (N is the multiplication speed and supports negative numbers), get I-frame is directly displayed. If each jump time, the jump time=N×1000−SD will be supplemented next time according to more than one second time difference SD.

FIG. 5 is a schematic diagram of a system architecture 500 that applies the information playing method provided by at least one embodiment of the present disclosure.

As shown in FIG. 5, the system architecture 500 comprises a playing module 501, a decoder module 503, and a shared memory 502.

The playing module 501 is used to execute a main thread, and the decoder module 503 is used to execute a decoding thread.

The playing module 501 comprises a buffer assembly 511. The buffer assembly 511 organizes the acquired media information to be played and provides the organized media information to be played to the shared memory 502.

The shared memory 502 comprises a player write unit 512 and a player read unit 522.

The player write unit 512 comprises a read memory 5121, a playing state storage memory 5122, and a read-in data cursor storage unit 5123. The player read unit 522 comprises a write-in memory 5221, a decoding state storage unit 5222, and a write-in data cursor storage unit 5224.

For example, the media information to be played is stored into the read-in memory 5121.

The decoder module 503 comprises a controller 513 and a ffmpeg decoder 523. The ffmpeg decoder 523 comprises a variety of pre-compiled decoding libraries to decode the media information to be played.

After the media information to be played is stored into the read-in memory 5121, the controller 513 is notified, and the controller 513 acquires the media information to be played from the read-in memory 5121 according to the position of the read-in data cursor in the read-in data cursor storage unit 5123, and decodes the media information to be played by using the ffmpeg decoder 523.

The controller 513 writes the playing information obtained by decoding into the write-in memory 5221.

The playing module 501 further comprises a video task manager 531, an audio task manager 521, an audio and video synchronizer 541, a webgl rendering unit 551 and an audio processing unit 561, and an image user interface 571.

The video task manager 531 and the audio task manager 521 acquire video data and audio data in the playing information from the write-in memory 5221, respectively, and organize the video data and the audio data to obtain a YUV task and a pcm task. The video task manager 531 and the audio task manager 521 send the YUV task and the pcm task to the audio and video synchronizer respectively, so that the audio and video synchronizer synchronizes the audio data and the video data to obtain the video playing task and the audio playing task. The audio and video synchronizer 541 performs, for example, the method described in FIG. 4.

The audio and video synchronizer provides the audio playing task to an audio processing unit (e.g., audio context interface) 561 and the video playing task to a webgl rendering unit (e.g., webgl renderer) 551. The audio processing unit 561 processes the audio playing task to obtain audio, and the webgl rendering unit 551 renders the video playing task.

As shown in FIG. 5, the playing module also comprises a graphical user interface 571 and an event collector 581.

The audio processing unit 561 and the webgl rendering unit 551 provide the processed audio playing task and the video playing task to the front-end graphical user interface 571.

The event collector 581 is used to acquire user operations on the graphical user interface 571. The event collector 581 provides user operations to the shared memory 502 and the audio and video synchronizer 541.

The user operations may be, for example, a pause operation, a close operation, a resume playing operation, a jump operation, and the like.

For example, the event collector 581 provides the acquired user operations to the shared memory 502, the shared memory 502 stores the user operations in the playing state storage memory 5122, and the controller controls the decoding operation of the ffmpeg decoder according to the state of the playing state storage memory 5122.

For example, the player supports user operations such as playing, pause/resume, stop, volume adjustment, full screen, playing progress bar, seek, and fast forward/rewind and so on. In addition to the general part of user action click events on web pages, the player provided by the present disclosure may further comprise the states recorded by the playing state storage memory 5122 corresponding to the states of ready, play, pause, and stop. For example, the playing state storage memory 5122 comprises command bits, which can affect the state bits of the read-in memory 5121. For example, if the player is paused, the read lock and write lock will be opened. For example, for a jump operation on a non real-time streams, the write-in memory 5221 is cleared and locked. After the jump ends, the lock on the write-in memory will be released. For example, ready, play, pause, jump, and stop correspond to byte codes 1 byte 0x00, 1 byte 0x01, 1 byte 0x02, 1 byte 0x03+8-bit unsigned long parameters (jump 0x03 represents addressing begins, and 0x04 represents jump addressing ends), and 1 byte 0x11 respectively in the playing state storage memory 5122 in FIG. 5. According to user operations, the corresponding byte codes will be updated to the aforementioned playing state storage memory 5122. This embodiment facilitates the decoder to know the state of the player in real time and make corresponding strategies to make the player play more efficiently.

The controller also determines whether to trigger the read lock and write lock according to the position of the read-in data cursor in the read-in data cursor storage unit 5123 and the position of the write-in data cursor in the write-in data cursor storage unit 5224. Refer to the description of FIG. 2B for the triggering and releasing of the read lock and write lock.

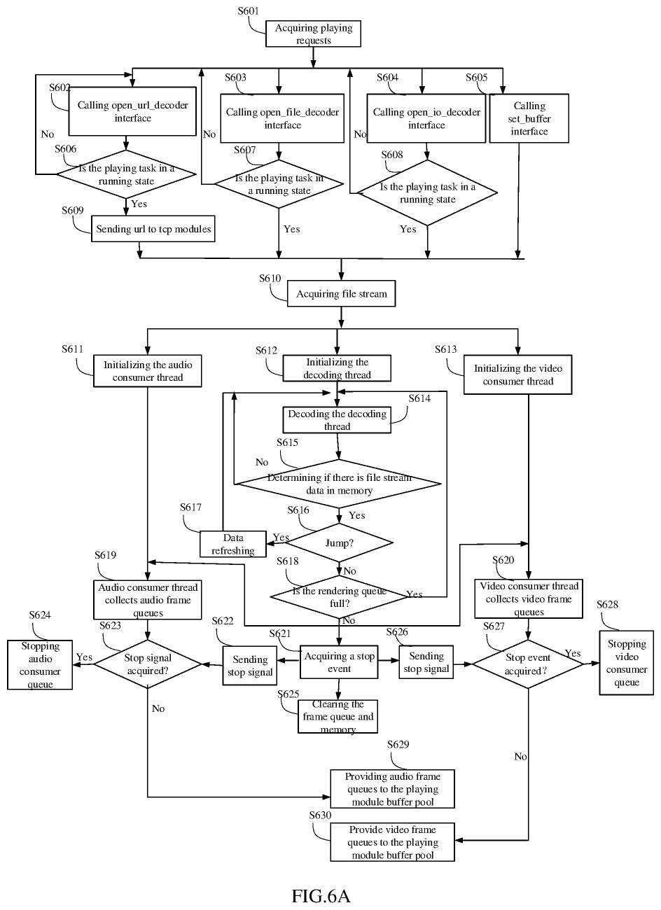

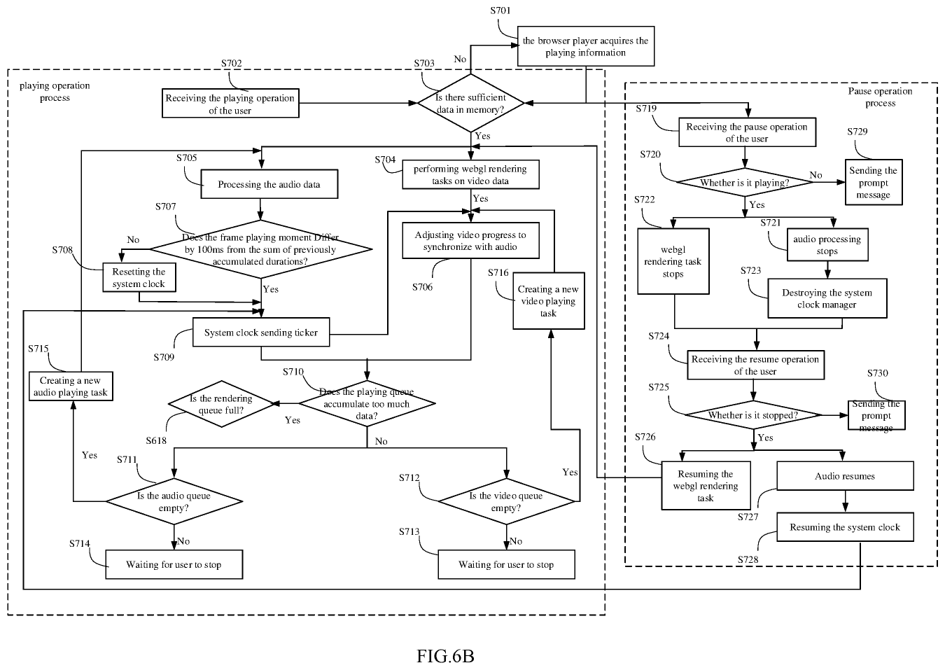

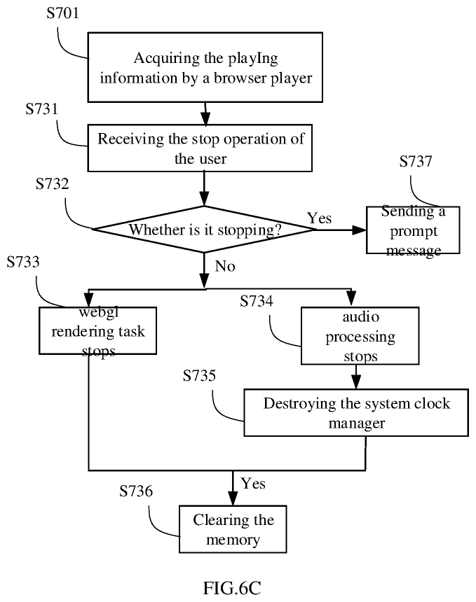

FIG. 6A˜FIG. 6C is a flowchart of another information playing method provided by at least one embodiment of the present disclosure.

The flowchart shown in FIG. 6A shows an initialization and a decoding thread in the information playing method. The decoding thread can be executed by the playing module 503 in FIG. 5. Initialization comprises initializing the decoding thread and initializing the main thread. The flowcharts shown in FIG. 6B and FIG. 6C show the main thread in the information playing method. The flowcharts shown in FIG. 6B and FIG. 6C can be executed by the playing module 501 in FIG. 5.

As shown in FIG. 6A, the information playing method may comprise steps S601˜S630.

Step S601: acquiring a playing request. For example, the browser acquires a playing request input by the user.

In some embodiments of the present disclosure, if the method for acquiring the media playing information is determined to be a url according to the playing request, step S602 is executed; if the method of acquiring the media playing information is determined to be a one-time read according to the playing request, step S603 is executed; If the method of acquiring the media playing information is determined to be a fragmented acquisition according to the playing request, step S604 is executed.

Step S602: calling the open_url_decoder interface. The open_url_decoder interface is used to process the playing task in the form of a url.

Step S603: calling the open_file_decoder interface. The open_file_decoder interface is used to handle the playing task in the form of one-time read.

Step S604: calling the open_io_decoder interface. The open_io_decoder interface is used to process the playing task in the form of a fragmented read.

In some embodiments of the present disclosure, the fragmented acquisition method is applied to the live broadcast mode, which requires constant updating of the ring caches, so if the method of acquiring the media playing information is fragmented acquisition according to the playing request, it is necessary to execute step S605 in addition to step S604.

Step S605: calling the set_buffer interface. The set_buffer interface is used to update the ring buffer.

Step S606: using the open_url_decoder interface to determine whether the playing task is in a running state. If the playing task is in the running state, execute step S609, and if the playing task is not in the running state, return to execute step S602.

Step S607: using the open_file_decoder interface to determine whether the playing task is in a running state. If the playing task is in the running state, execute step S610, and if the playing task is not in the running state, return to execute step S603.

Step S608: using the open_io_decoder interface to determine whether the playing task is in a running state. If the playing task is in the running state, execute step S610, if the playing task is not in the running state, return to execute step S604.

Step S609: sending a url to a tcp module so that the tcp module can acquire a file stream. The file stream here is the media information to be played.

Step S610: acquiring the file stream and put the file stream into the shared memory.

Step S611: initializing the audio consumer thread. After completing the execution of step S611, execute step S614.

Step S612: initializing the decoding thread.

Step S613: initializing the video consumer thread. After completing the execution of step S613, execute step S620.

Step S614: the decoding thread decodes to obtain playing information.

Step S615: determining whether there is file stream data in the write-in memory. If there is still file stream data in the write-in memory, execute step S616. If there is no file stream data in the write-in memory, return to execute step S614.

Step S616: determining whether to jump. For example, if a jump operation is received, it will jump, and if no jump operation is received, it will not jump.

For example, if there is a jump, proceed to step S618, and if there is no jump, proceed to step S617.

Step S617: performing data refresh. For example, update the decoding packet and reset the write-in data cursor, while the decoder gets the jump state and interrupts the decoding and enters the jump process, clearing the write-in memory.

Step S618: determining whether the rendering queue is full. The rendering queue stores the queue that needs webgl rendering. If the rendering queue is full, execute step S614. If the rendering queue is not full, execute step S619 and step S620.

Step S619: the audio consumer thread collects the audio frame queue decoded by the decoding thread.

Step S620: the video consumer thread collects the video frame queue decoded by the decoding thread.

Step S621: acquiring a stop event. For example, the stop event can be triggered by a stop operation of the user.

Step S622: sending a stop signal to the audio consumer queue in response to acquiring the stop event.

Step S623: the audio consumer queue determines whether the stop signal is received. If the stop signal is received, execute step S264, and if the stop signal is not received, execute step S629.

Step S264: stopping the operation of the audio consumer queue.

Step S625: clearing the frame queue and the memory.

Step S626: sending a stop signal to the video consumer queue in response to acquiring the stop event.

Step S627: determining whether the stop signal is received by the video consumer queue. If the stop signal is received, execute step S268, and if the stop signal is not received, execute step S630.

Step S628: stopping the video consumer queue.

Step S629: providing the audio queue to the playing module buffer pool.

Step S630: providing the video queue to the playing module buffer pool.

FIG. 6B is a flowchart of a method executed by a user triggered playing operation and a user triggered pause operation, and FIG. 6C is a flowchart of a method executed by a user triggered pause operation.

As shown in FIG. 6B, the steps executed by the main thread comprise step S701, steps S702˜S716 and step S618 executed by the user triggered playing operation, and steps S719˜S730 executed by the user triggered pause operation.

If the user triggers the playing operation, execute steps S702˜S717. If the user triggers the pause operation, execute steps $719˜S730.

Step S701: acquiring playing information by a browser player (i.e., the main thread).

The playing information comprises an audio frame queue and a video frame queue. The main thread is utilized to acquire the audio frame queue and the video frame queue from the buffer pool of the playing module. Step S701 is executed, for example, after step S629 and step S630 in FIG. 6A.

Step S702: receiving the playing operation of the user.

Step S703: determining whether the data in the memory is sufficient for playing. If the data in the memory is sufficient, execute step S704 and step S705; if the data in the memory is not sufficient, execute step S701. For example, for audio data, if the amount of audio data in the memory is greater than an audio threshold (e.g., 10k as mentioned above), the audio data is sufficient. For video data, if the amount of video data in memory is greater than the video threshold, it indicates that the video data is sufficient. The video threshold may be, for example, the amount of data for 1 frame of video, the amount of data for 2 frames of video, etc.

Step S704: executing a webgl rendering task on the video data. The video data is the video data in the video frame queue.

Step S705: processing the audio data. For example, the audio data is processed by calling the audio context scheduled source node interface, which is part of the Web Audio API and is the parent interface of various audio source node interfaces. This interface defines the start and stop methods of audio and event processing procedures.

Step S706: adjusting the video progress to synchronize with the audio. The method for adjusting the video progress may be the method described in FIG. 4A above and will not be repeated here.

Because the audio is bound to the system timeline, it is only necessary to adjust the video progress to synchronize with the audio.

Step S707: determining whether the frame playing moment (i.e., PTS) differs by 100 ms from the sum of the previously accumulated durations.

If the PTS differs 100 ms from the sum of the previously accumulated durations, execute step S709; if the PTS does not differ by 100 ms from the sum of the previously accumulated durations, execute step S708 first and then step S709.

Step S708: resetting the system clock so that the system timeline is aligned with the audio.

Step S709: the system clock keeps sending tickers. After adjusting the system clock, it is necessary to execute step S706 again.

Step S710: determining whether the playing queue has accumulated excessive data. If the playing queue has accumulated excessive data, execute step S717; if the playing queue has not accumulated excessive data, execute step S711 and step S712. For example, if the data in the playing queue is greater than a preset threshold, it is determined that the playing queue has accumulated excessive data. The preset threshold may be set by those skilled in the art himself as needed.

Step S711: determining whether the audio queue in the playing queue is empty. If the audio queue is empty, execute step S715; if the audio queue is not empty, execute step S714.

Step S712: determining whether the video queue in the playing queue is empty. If the video queue is empty, execute step S716; if the video queue is not empty, execute step S713.

Step S713 and step S714: waiting for user's stop operation.

Step S715: creating a new audio playing task and executing step S705 again.

Step S716: creating a new video playing task and executing step S704 again.

Step S717: returning back to step S618 in FIG. 6A again.

If step S717 is executed, the steps executed after step S618 and step S618 are continued according to the method of FIG. 6A.

If a user triggers a pause operation, then execute steps S719˜S730 after executing step S701.

Step S719: receiving the pause operation of the user.

Step S720: determining whether the audio and video are being played. If the audio and video are being played, then execute steps S721 and S722.

Step S721: audio processing pauses. For example, Audio Context enables pause state.

Step S722: the video frame task hangs the rendering task for the next frame. Step S721 and step S722 are similar to step S401 in FIG. 4B.

Step S723: destroying the system clock manager. That is, the system time ticker is interrupted. For example, the pause moment UPTS (i.e., the first moment) will be recorded when simultaneous recording pauses, the time being played at the time of pause. The time being played at the time of pause is the second duration UPT between the actual playing moment of when the first frame starts playing and the first moment. Step S723 is similar to steps S402 and S403 in FIG. 4B.

Step S724: receiving the resume operation of the user. The resume moment URTS when the resume operation is acquired is recorded, the ticker jump is resumed and the CT and TT of the ticker are updated to PT and PTT.

Step S725: determining whether the playing of the audio and video has been paused.

If it has been paused, execute step S726 and step S727. If it has not been paused, execute step S730.

Step S726: resuming the webgl rendering task.

Step S727: resuming audio processing. For example, Audio Context starts running.

Step S728: resuming system clock. For example, updating the scheduled execution moment PSTS of the current frame to URTS, updating the scheduled execution duration PTD of the current frame to RFST, updating the actual execution moment ASTS of the task to URTS, updating the actual execution duration ATD of the task to RFST, updating CT to UPT, and updating TT to URTS, i.e., restarting the task queue.

Step S728 is similar to steps S404˜S407 described in FIG. 4B above.

Step S729 and step S730: sending a prompt message to the user to indicate abnormal operation.

As shown in FIG. 6C, the method for triggering a pause operation by the user may comprise step S701 and steps S731˜S737.

For step S701, please refer to the description of FIG. 6B.

Step S731: receiving the stop operation of the user.

Step S732: determining whether the playing of the audio and video has been stopped. If the playing of the audio and video has not been stopped, execute step.

Step S733: stopping the webgl rendering task.

Step S734: stopping audio processing. For example, Audio Context stops working.

Step S735: destroying the system clock manager.

Step S736: clearing the memory.

Step S737: sending a prompt message to remind the user that the audio and video have been stopped.

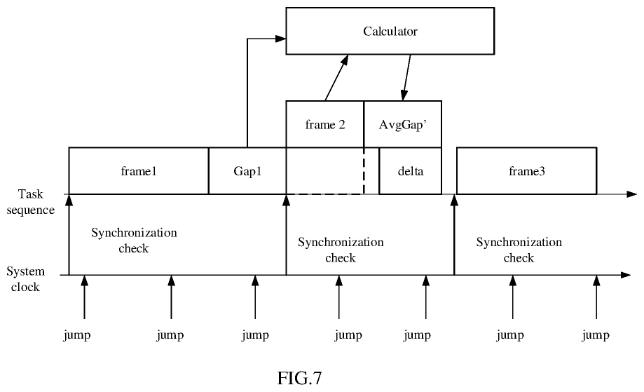

FIG. 7 is a schematic diagram of synchronization between video playing tasks and audio playing tasks provided by at least one embodiment of the present disclosure.

As shown in FIG. 7, the task sequence comprises the first video frame frame1, the second video frame frame2, and the third video frame frame3.

As shown in FIG. 7, an audio and video synchronization check is performed prior to the playing of each video frame (the first video frame frame1, the second video frame frame2, and the third video frame frame3). Because the binding of audio to the system clock, video frames only need to be synchronized with the system clock.

For example, the synchronization check is performed before playing the second video frame frame2. Performing the synchronization check may be, for example, by a calculator performing step S441 in FIG. 4A and calculating a delay duration Gap1 of the video playing task for the current frame.

After obtaining the delay duration Gap1, the calculator calculates the actual playing duration of the video playing task for the second video frame according to step S442 and step S443 in FIG. 4A.

As shown in FIG. 7, the calculator calculates to obtain an average delay duration AvgGap′, and obtains the actual playing duration of the video playing task for the second video frame according to the average delay duration AvgGap′ as the sum of the originally scheduled execution duration of the second video frame frame2 and the increased playing duration delta.

FIG. 8 is a block diagram of a browser-based information playing apparatus 800 provided by at least one embodiment of the present disclosure.

For example, as shown in FIG. 8, the information playing apparatus 800 comprises an acquisition unit 810, a selection unit 820, a decoding unit 830, and a playing unit 840.

The acquisition unit 810 is configured to acquire media information to be played.

The acquisition unit 810, for example, may execute step S10 described in FIG. 1.

The selection unit 820 is configured to select a target decoding library from a plurality of decoding libraries according to the attributes of the media information to be played. A plurality of decoding libraries are obtained by pre-compiling the decoding program in multiple ways respectively.

The selection unit 820, for example, may execute step S20 described in FIG. 1.

The decoding unit 830 is configured to using the target decoding library to decode the media information to be played to obtain the playing information.

The decoding unit 830, for example, may execute step S30 described in FIG. 1.

The playing unit 840 is configured to play the playing information based on a browser.

The playing unit 840, for example, may execute step S40 described in FIG. 1.

For example, the acquisition unit 810, the selection unit 820, the decoding unit 830, and the playing unit 840 may be hardware, software, firmware, and any feasible combination thereof. For example, the acquisition unit 810, the selection unit 820, the decoding unit 830, and the playing unit 840 may be specialized or general-purpose circuits, chips, or devices, etc., or may be a combination of a processor and a memory. With respect to the specific implementation forms of each unit mentioned above, the embodiments of the present disclosure are not limited to this.

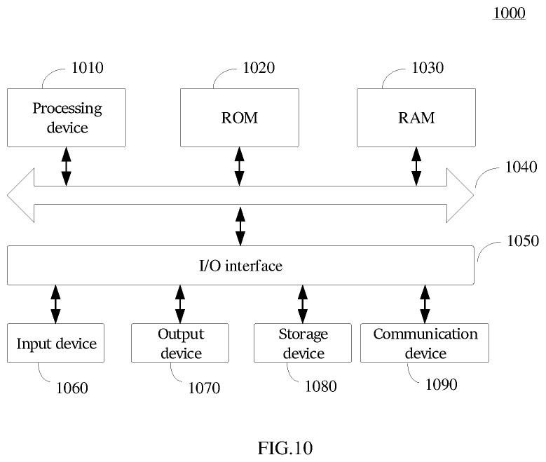

It should be noted that in the embodiments of the present disclosure, each unit of the information playing apparatus 800 corresponds to each step of the aforementioned information playing method. For specific functions of the information playing apparatus 800, please refer to the relevant description of the information playing method, which will not be repeated here. The components and structure of the information playing apparatus 800 shown in FIG. 10 are merely exemplary and not restrictive, and the information playing apparatus 800 may also comprise other components and structures as needed.

At least one embodiment of the present disclosure also provides an electronic device that comprises a processor and a memory. The memory comprises one or more computer program modules. The one or more computer program modules are stored in the memory and configured to be executed by the processor. The one or more computer program modules comprise instructions for implementing the information playing method described above. The electronic device can alleviate the problem of multimedia being difficult to play on a browser in a complex codec environment.

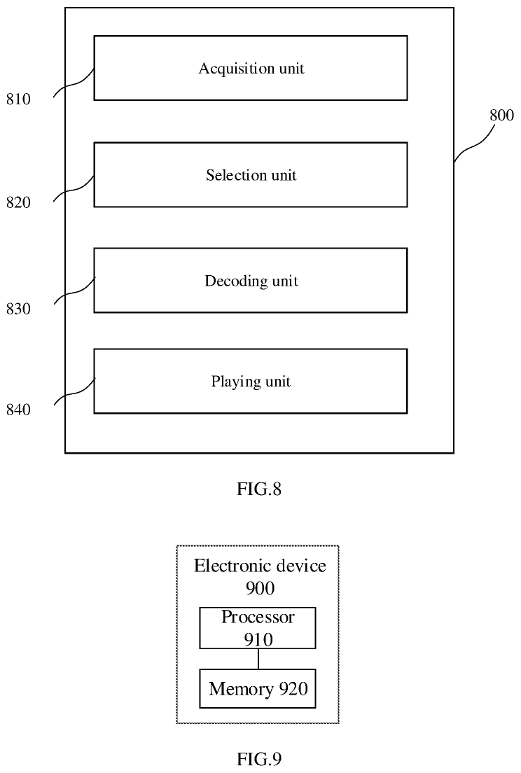

FIG. 9 is a schematic block diagram of an electronic device provided by some embodiments of the present disclosure. As shown in FIG. 9, the electronic device 900 comprises a processor 910 and a memory 920. The memory 920 is used to store non-transient computer-readable instructions (e.g., one or more computer program modules). The processor 910 is used to run the non-transient computer-readable instructions, and the non-transient computer-readable instructions may perform one or more steps in the information playing method described above when run by the processor 910. The memory 920 and the processor 910 may be interconnected via a bus system and/or other forms of connection mechanisms (not shown).

For example, the processor 910 can be a central processing unit (CPU), a graphics processing unit (GPU), or other forms of processing unit having data processing capabilities and/or program execution capabilities. For example, the central processing unit (CPU) can be an X86 or ARM architecture, etc. The processor 910 can be a general-purpose processor or a specialized processor that can control other components in the electronic device 900 to perform desired functions.

For example, the memory 920 may comprise any combination of one or more computer program products, and the computer program products can comprise various forms of computer-readable storage media, such as volatile memory and/or non-volatile memory. The volatile memory, for example, may comprise random access memory (RAM) and/or cache memory (cache), among others. The non-volatile memory may for example comprise read-only memory (ROM), hard disks, erasable programmable read-only memory (EPROM), portable compact disk read-only memory (CD-ROM), USB memory, flash memory, and the like. One or more computer program modules can be stored on a computer-readable storage medium, and the processor 910 may run one or more computer program modules to implement various functions of the electronic device 900. Various applications and various data and various data used and/or generated by the applications and the like can also be stored in the computer-readable storage medium.

It should be noted that in the embodiments of the present disclosure, the specific functions and technical effects of the electronic device 900 can refer to the above description of the information playing method and will not be repeated here.

FIG. 10 is a schematic block diagram of another electronic device provided by some embodiments of the present disclosure. The electronic device 1000 is suitable for use, for example, to implement the information playing method provided by embodiments of the present disclosure. The electronic device 1000 may be a terminal device, etc. It should be noted that the electronic device 1000 shown in FIG. 10 is merely an example and does not impose any limitations on the functionality and scope of use of the embodiments of the present disclosure.

As shown in FIG. 10, the electronic device 1000 may comprise a processing device (for example, a central processor, a graphics processor, etc.) 1010 that may perform various appropriate actions and processes according to programs stored in a read-only memory (ROM) 1020 or programs loaded from a storage device 1080 into a random access memory (RAM) 1030. Various programs and data necessary for the operation of the electronic device 1000 are also stored in the RAM 1030. The processing device 1010, ROM 1020, and RAM 1030 are connected to each other through a bus 1040. An input/output (I/O) interface 1050 is also connected to the bus 1040.

Generally, the following devices can be connected to an I/O interface 1050: an input device 1060 comprising, for example, a touch screen, a touch pad, a keyboard, a mouse, a camera, a microphone, an accelerometer, a gyroscope, and the like; an output device 1070 comprising, for example, a liquid crystal display (LCD), a speaker, a vibrator, and the like; a storage device 1080 comprising, for example, a magnetic tape, a hard disk, and the like; and a communication device 1090. The communication device 1090 can allow the electronic device 1000 to have wireless communication or wired communication with other electronic devices to exchange data. While FIG. 8B shows the electronic device 1000 with a variety of devices, it should be understood that it is not required to implement or have all of the illustrated devices, and the electronic device 1000 can alternatively implement or have more or less devices.

For example, according to embodiments of the present disclosure, the information playing method described above can be implemented as a computer software program. For example, embodiments of the present disclosure comprise a computer program product comprising a computer program carried on a non-transient computer-readable medium. The computer program comprises program codes for performing the information playing method described above. In such embodiments, the computer program can be downloaded and installed from network via a communication device 1090, or installed from a storage device 1080, or installed from a ROM 1020. When the computer program is executed by the processing device 1010, the functions defined in the information playing method provided by embodiments of the present disclosure can be realized.

At least one embodiment of the present disclosure further provides a computer-readable storage medium. The computer-readable storage medium is used to store non-transient computer-readable instructions. The information playing method described above can be realized when the non-transient computer-readable instructions are executed by a computer. The computer-readable storage medium can be utilized to alleviate the problem of multimedia being difficult to play on a browser in a complex codec environment.

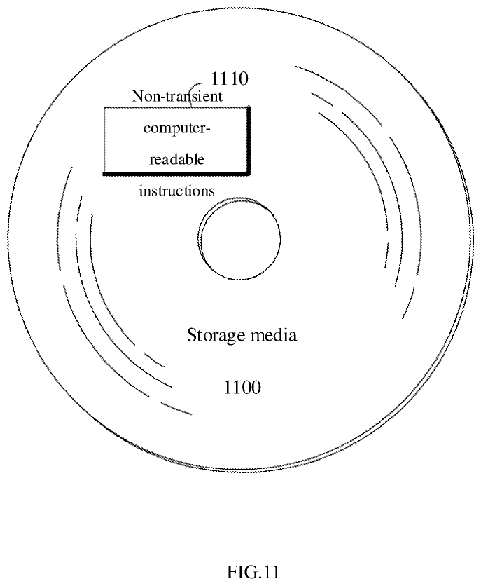

FIG. 11 is a schematic diagram of a storage medium provided by some embodiments of the present disclosure. As shown in FIG. 11, the storage medium 1100 is used to store non-transient computer-readable instructions 1110. For example, the non-transient computer-readable instructions 1110 can perform one or more steps in the information playing method described above when executed by a computer.

For example, the storage medium 1100 can be applied in the electronic device 900 described above. For example, the storage medium 1100 can be a memory 920 in the electronic device 900 shown in FIG. 9. For example, a related description of the storage medium 1100 can refer to the corresponding description of the memory 920 in the electronic device 900 shown in FIG. 9 and will not be repeated here.

For the present disclosure, the following statements should be noted:
(1) The drawings of the present disclosure involve only the structure(s) in connection with the embodiment(s) of the present disclosure, and other structure(s) can be referred to common design(s).
(2) In case of no conflict, features in one embodiment or in different embodiments can be combined to obtain new embodiments.

What have been described above are only exemplary embodiments of the present disclosure, and are not intended to limit the protection scope of the present disclosure, and the protection scope of the present disclosure is determined by the appended claims.

1. A browser-based information playing method, comprising:
acquiring media information to be played;
selecting a target decoding library from a plurality of decoding libraries according to attributes of the media information to be played, wherein the plurality of decoding libraries are obtained by pre-compiling a decoding program in multiple ways respectively;
utilizing the target decoding library to decode the media information to be played to obtain playing information; and
playing the playing information based on the browser.

2. The information playing method according to claim 1, further comprising:
creating a shared memory of a main thread and a decoding thread before acquiring the media information to be played, wherein the shared memory comprises a read-in memory;
wherein acquiring the media information to be played comprises:
acquiring the media information to be played by the main thread and storing the media information to be played in the read-in memory;
wherein utilizing the target decoding library to decode the media information to be played to obtain the playing information comprises:
the decoding thread acquiring the media information to be played from the read-in memory and utilizing the target decoding library to decode the media information to be played to obtain the playing information.

3. The information playing method according to claim 2, wherein acquiring the media information to be played by the main thread and storing the media information to be played to the read-in memory comprises any of the following:
acquiring, by the main thread, a uniform resource locator for the media information to be played, and acquiring the media information to be played based on the uniform resource locator, and storing the media information to be played into the read-in memory;
acquiring the media information to be played by the main thread by a single read operation, providing the media information to be played to the read-in memory; or
fragmenting the media information to be played into a plurality of media fragments, sequentially acquiring the plurality of media fragments by the main thread, sequentially storing the plurality of media fragments into the read-in memory.

4. The information playing method according to claim 3, wherein in response to fragmenting the media information to be played into the plurality of media fragments, the read-in memory comprises ring memory.

5. The information playing method according to claim 4, wherein a read-in data cursor is provided in the ring memory, the read-in data cursor indicates a current location in the ring memory where the media information to be played has been read by the decoding thread; and
the method further comprises:
in response to a data length of a current media fragment exceeding a memory length remaining in the ring memory, at least a portion of the data of the current media fragment overwrites a memory space between a queue head pointer of the ring memory to a location where the read-in data cursor is located.

6. The information playing method according to claim 5, further comprising:
triggering a read lock in response to the data length of the current media fragment being greater than an available length,
wherein the available length is equal to a sum of a difference between a total length of the read-in memory and a length of the media information currently stored in the read-in memory and a length between the queue head pointer of the read-in memory and the position where the read-in data cursor is located.

7. The information playing method according to claim 6, further comprising:
updating the read-in data cursor after the decoding thread consumes the data in the read-in memory;
updating the available length in the read-in memory according to an updated read-in data cursor;
releasing the read lock in response to an updated available length in the read-in memory being greater than or equal to a data length of the current media fragment; and
updating a flag bit in the shared memory to notify the decoding thread and the main thread that the read lock is released.

8. The information playing method according to claim 2, wherein, the shared memory further comprises a write-in memory, decoded playing information is written to the write-in memory; and
playing the playing information based on the browser comprises:
reading the decoded playing information from the write-in memory;
sequentially generating a plurality of media playing tasks based on the playing information; and
executing the plurality of media playing tasks to play the playing information.

9. The information playing method according to claim 8, wherein the write-in memory is a ring memory and the write-in memory is provided with a write data cursor, and the method further comprises:
triggering a write lock in response to a data length of decoded data decoded and obtained by the decoding thread being greater than an available write-in memory length, wherein the decoded data is a portion of data in the playing information,
wherein the available write-in memory length is equal to a sum of a difference between a total length of the write-in memory and a length of the decoded data currently stored in the write-in memory and a length between a queue head pointer of the write-in memory and a position where the write data cursor is located.

10. The information playing method according to claim 9, further comprising:
updating the write data cursor after the main thread consumes the data in the write-in memory;
updating an available length in the write-in memory according to an updated write data cursor;
releasing the write lock in response to an updated available length in the write-in memory being greater than or equal to a data length of the decoded data; and
updating a flag bit in the shared memory to notify the decoding thread and the main thread that the write lock is released.

11. The information playing method according to claim 2, wherein the browser further comprises a browser database, decoded playing information is written to the browser database; and
playing the playing information based on the browser comprises:
reading the decoded playing information from the browser database;
sequentially generating a plurality of media playing tasks based on the playing information; and
executing the plurality of media playing tasks to play the playing information.

12. The information playing method according to claim 8, wherein the playing information comprises video data, and the plurality of media playing tasks comprises at least one video playing task; and
sequentially generating the plurality of media playing tasks based on the playing information comprises:
rendering the video data to sequentially generate the at least one video playing task.

13. The information playing method according to claim 8, wherein the playing information further comprises audio data, the plurality of media playing tasks comprises at least one audio playing task; and
sequentially generating the plurality of media playing tasks based on the playing information further comprises:
creating at least two audio task caches; and
sequentially injecting the audio data in different time periods into the at least two audio task caches, wherein playing the audio data in each audio task cache is treated as an audio playing task.

14. The information playing method according to claim 13, wherein sequentially generating the plurality of media playing tasks based on the playing information further comprises:
adjusting progress of the at least one audio playing task and the at least one video playing task, such that the at least one audio playing task and the at least one video playing task are synchronized.

15. The information playing method according to claim 14, wherein each video frame is played as a video playing task, and adjusting the progress of the at least one video playing task comprises:
calculating, before each video playing task is executed, a delay duration of the video playing task for a current frame;
updating an average delay duration based on the delay duration of the video playing task and an average delay duration of a history frame played before the current frame; and
determining an actual playing duration of the video playing task and an execution moment of the video playing task for a next frame according to an updated average delay duration and a scheduled execution duration of the video playing task;
wherein calculating, before each video playing task is executed, the delay duration of the video playing task for the current frame comprises:
acquiring a display timestamp of the current frame in the media information to be played;
acquiring the scheduled execution duration of the video playing task;
acquiring a first duration between an actual playing moment of starting playing of a first frame and an actual playing moment of the current frame; and
taking a first difference between the first duration and the display timestamp and a second difference between the scheduled execution duration as the delay duration of the current frame in the video playing task.

16. (canceled)

17. The information playing method according to claim 14, further comprising:
suspending the audio playing task in response to acquiring a pause operation at the first moment, the video playing task suspending a rendering task of a next frame;
recording a second duration between an actual playing moment of starting playing of the first frame and the first moment;
determining a remaining display duration of the current frame according to the second duration;
in response to acquiring a resume operation, recording a resume moment at which the resume operation is acquired;
updating a scheduled execution moment of the current frame to the resume moment;
updating a scheduled execution duration of the current frame to the display duration; and
updating the first duration to the second duration.

18. The information playing method according to claim 1, further comprising:
determining a first key frame of a gop interval of a frame corresponding to a second moment in response to acquiring a jump operation at the second moment;
calculating a duration of each frame according to a frame rate; and
determining a target frame to start playing from the target frame according to the duration of each frame.

19. A browser-based information playing apparatus, comprising:
an acquisition unit configured to acquire media information to be played;
a selection unit configured to select a target decoding library from a plurality of decoding libraries according to attributes of the media information to be played, wherein the plurality of decoding libraries are obtained by pre-compiling a decoding program in multiple ways respectively;
a decoding unit configured to utilize the target decoding library to decode the media information to be played to obtain playing information; and
a playing unit configured to play the playing information based on the browser.

20. An electronic device, comprising:
a processor;
a memory comprising one or more computer program instructions;
wherein the one or more computer program instructions are stored in the memory and implement the instructions of the information playing method of claim 1 when executed by the processor.

21. A computer-readable storage medium non-transitorily storing computer-readable instructions, wherein the computer-readable instructions implement the information playing method of claim 1 when executed by a processor.
